(19) United States
(12) Patent Application Publication
(10) Pub. No.: US 2005/0264158 A1
(43) Pub. Date: Dec. 1, 2005

(54) Lens system for manufacturing crt screens

(75) Inventor: Albertus Aemilius Seyno Sluyterman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/520,486

(22) PCT Filed: Jun. 18, 2003
(86) PCT No.: PCT/IB03/02748

§ 371 Date: Jan. 7, 2005

(30) Foreign Application Priority Data
Jul. 11, 2002 (EP) 020778353

(51) Int. Cl. H01J 29/10

(52) U.S. Cl. 313/461

(57) ABSTRACT

A lens system (10, 20) is disclosed, comprising a first (13, 23) and a second (11, 21) lens. The refractive index of the second lens (11, 21) is higher than that of air, but lower than the refractive index of the first lens (13, 23). The lenses (13, 11, 23, 21) are arranged in direct contact with each other such that a critical refractive interface (22) is formed. The invention provides for exposure of CRT screens with a lower sensitivity to surface roughness, in particular when manufacturing screens with large deflection angles.

This invention relates to a lens system for use in manufacturing CRT screens.

In the manufacturing process of CRT screens, phosphor and matrix layers are applied by means of a photographic process. In the process, lenses are used for exposing the screen. The demands on the optical quality of these lenses are constantly increasing.

One of the problems concerning these lenses is their surface roughness, which reduces the optical accuracy of the lenses. This is a big problem, in particular in slim tubes, i.e. tubes with a large deflection angle, for example up to 120°.

The phosphor and matrix layers on a CRT screen are made by means of a photographic process, for which a shadow mask is used as a negative. The light rays used in this process must look like the future electron beam rays, i.e. when the tube is in operation. This holds for all CRTs that are made today. What is typical for the lenses used in CRT exposure is that they are relatively large having diameters of more than 10 cm. Usually one side of the lens is flat while the other side has a refractive structure defining the optical properties of the lens. As is known in the art, the refractive surface of an exposure lens for use in manufacturing CRT screens is generally aspherical and non-parabolic (as opposed to lenses for use in cameras or telescopes). The refractive structure is often made by means of a so-called “sagging” process (where a glass plate follows the shape of a mould when the mould and the glass plate are heated) or by means of a grinding process. However, these processes of making lenses are limited in their accuracy regarding the surface roughness of the refractive structure.

Therefore the problem to be solved is how to increase the accuracy of an exposure lens. This problem is more urgent now than it was in the past, due to increased deflection angles. The larger the deflection angle, the larger is the angle at which the light goes through the lens, and thus, the larger the negative effect is from the surface roughness. When light goes through a lens at a large angle, the effect of surface roughness increases dramatically. For a 120° CRT, the effect of the surface roughness of the lens is 60% larger than for a 110° CRT.

Therefore, it is an object of the present invention to provide a lens system for which the influence from surface roughness is substantially reduced. This is achieved by a lens system according to the appended claim 1.

For the understanding of the invention it is important to distinguish between the refractive structure of the lens and the roughness of the surface. When designing the lens, the surface structure is determined so as to create a lens having the desired refractive properties. Within certain limits, the lens can be given an arbitrary shape. Theoretically, the optical refraction properties of the lens can be predicted fully in the design process, and they are determined by the refractive structure of the lens. However, when constructing the lens, be it by sagging, grinding or any other known way, the lens surface will always differ somewhat from the designed refractive structure, due to the surface roughness. Every surface always exhibits some degree of roughness, but in a lens for manufacturing CRT screens this is acceptable only to a limited degree.

The problem to be solved is, as mentioned above, how to enhance the accuracy of a lens. Instead of focusing on improving surface smoothness, to which there clearly is a limit, the invention takes a totally different approach.

The invention is based on the recognition that the magnitude of the optical disturbances is not only proportional to the surface roughness, but also to the refractive index of the lens or more particularly the difference between the refractive indices on each side of a refractive interface.

Therefore, reducing the refractive index is an alternative way of enhancing the lens accuracy. Of course, to maintain the refractive characteristics (the refractive power) of the lens when reducing the refractive index, the structure of the lens refractive surface has to be accentuated accordingly. Within certain limits, accentuating the surface is not a problem. However, no lens material having a low enough refractive index is known. Therefore this solution is not feasible today.

Hence, it is the difference in refractive indices of the lens and the surrounding medium that determines the refractive power. This opens for a still different approach to the problem. For example, by submerging a glass lens, having a refractive index of 1.54, in water, having a refractive index of 1.33, the same refractive effect will be achieved as if a lens having a refractive index of 1.21 is used in air, having the refractive index 1.00. However, even if this is theoretically feasible, such a solution may be too impractical for standard use.

Furthermore, it is realized that a flat lens surface can be easily manufactured with sufficiently good tolerances for the surface roughness. In other words, a flat surface with excellent optical properties is easier to make than a curved surface with said excellent properties, in particular when the shape of the surface is determined by a sagging process.

According to one embodiment of the invention, a lens having insufficient surface smoothness is encapsulated in a box filled with a transparent liquid. The flat sides of the box can be made with sufficient smoothness and the liquid can be selected to have a refractive index lower than that of the glass lens. Such a configuration will result in a lens system which is much less sensitive to the surface roughness of the lens, and which is usable in the manufacturing process of CRT screens with large deflection angles.

In a preferred embodiment of the invention, the lens system comprises a first and a second lens. The first lens corresponds to the lens discussed above, having a refractive surface with unacceptable surface roughness. The second lens, which has a lower refractive index than the first lens, has a refractive surface whose shape is complementary to the refractive surface of the first lens and is arranged in direct contact with the refractive surface of the first lens. As a result, the two lenses form a single composite lens, or a lens system, having an internal refractive interface.

Preferably, the two outer lens surfaces of the composite lens are flat, and can thus be made with sufficient smoothness. In this way, a composite lens system having sufficient refraction accuracy can be assembled with lenses that, when used separately, have insufficient accuracy. Of course, the internal refractive interface of the composite lens will have to be designed differently depending on which particular refractive indices the lens materials have, and also depending on the chosen design of the entrance and exit surfaces of the composite lens.

The materials in the lenses are chosen such that the difference in refractive indices is sufficiently small. Of course, the difference cannot be too small. The smaller the difference, the more magnified, or accentuated, the refractive structure of the interface has to be. Since there are limits to the design of the structure, there are limits to the degree of the index difference as well. However, the combination of quartz in the first lens and glass in the second lens is one preferred selection.

Generally, the lens system according to the invention is designed such that the refractive power of a first lens is reduced compared with an ordinary, single lens system. As a result, the sensitivity to surface roughness of the first lens is reduced. The reduction of the refractive power of the first lens is achieved by arranging a refractive surface of said lens in direct contact with a second lens, having a lower refractive index than said first lens, but a higher refractive index than air. In this way, a critical refractive interface is achieved between said two lenses, wherein the refractive power, and thereby the sensitivity to roughness, is decreased as compared to a standard lens-air interface.

In the following, embodiments of the present invention will be described with reference to the accompanying drawings, in which:

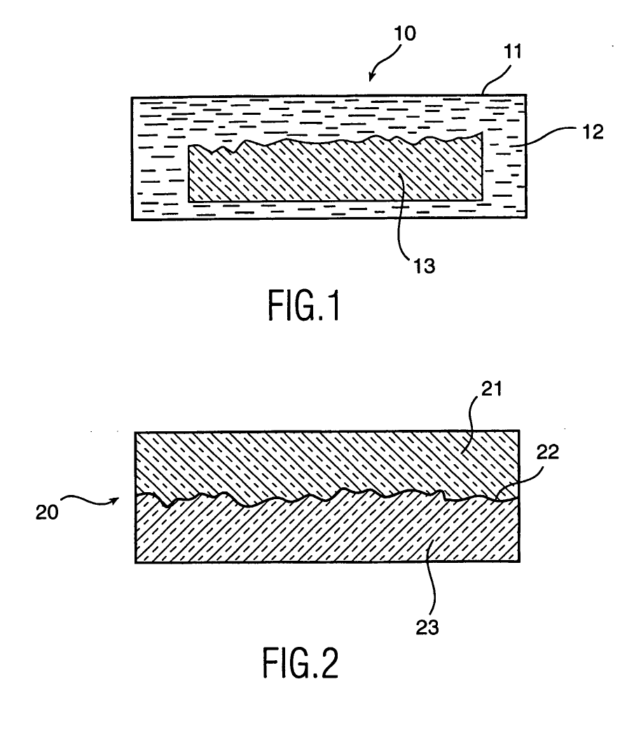

FIG. 1 schematically shows a lens encapsulated in a transparent box filled with transparent liquid.

FIG. 2 schematically shows a composite lens system comprising a first and a second lens.

In a first preferred embodiment, described with reference to FIG. 1, a lens system 10 comprises a first lens 13 which is submerged in a transparent liquid 12. The liquid 12 constitutes a second lens and has a refractive index which is higher than that of air but smaller than the refractive index of the first lens. The liquid is enclosed in a transparent container 11, which preferably has flat sides. In this embodiment, the first lens 13 is made from glass, having a refractive index of 1.54, and is submerged in water 12, having a refractive index of 1.33. As a result the first lens 13 loses 70% of its refractive effect, and thus also of its sensitivity to surface roughness. The water 12 is encapsulated in a glass container 11, having flat side surfaces with sufficient smoothness. It is to be understood that flat surfaces can be made with much higher accuracy than structured surfaces. The environment outside the glass container 11 may be air, as for a standard lens according to the prior art. The critical refractive interface of the lens system shown in FIG. 1 is the interface between the first lens 13 and the water 12. Naturally, the water 12 (constituting the second lens) complements the structured surface of the first lens, thus forming the critical refractive interface.

In a second, more practical embodiment, described with reference to FIG. 2, the lens system is actually a composite lens 20 comprising a first lens 23 and a second lens 21. The first lens 23 has a first refractive index and the second lens 21 has a second refractive index, which is lower than the first refractive index. The lenses each have a refractive surface, which have complementary shapes and are arranged in direct contact with each other, thus forming a critical refractive interface 22. Preferably, the outer surfaces of the composite lens are flat and can thus be made with sufficient smoothness. Any refraction pattern can thus be accomplished by designing the refractive interface accordingly. The composite lens 20 is preferably made by designing and manufacturing one of the lenses, and then manufacturing the other lens based on the shape of the lens manufactured first. In this embodiment, the first lens 23 is made from quartz, and the refractive surface is either formed by a grinding process or by a sagging process. The second lens 21 is made from glass, and is formed by melting the second lens 21 on top of the refractive surface of the first lens. Alternatively the second lens 21 can be formed in a similar process as the first lens 23, such that it exactly matches (is complementary to) the shape of the refractive surface of the first lens, and is then joined with said refractive surface.

It is to be understood that any optically transparent material can be used for the first and the second lens in the lens system according to the invention. For example, optic grade plastic can be used. Furthermore, an optical contact liquid or glue may be used at the interface between the first and the second lens in the case when two solid materials are used.

Summarizing, a lens system 10, 20 is disclosed, comprising a first 13, 23 and a second 11, 21 lens. The refractive index of the second lens 11, 21 is higher than that of air, but lower than the refractive index of the first lens 13, 23. The lenses 13, 11, 23, 21 are arranged in direct contact with each other such that a critical refractive interface 22 is formed. The invention provides for exposure of CRT screens with a lower sensitivity to surface roughness, in particular when manufacturing screens with large deflection angles.

1. A lens system for use in manufacturing CRT screens, the lens system comprising:
a first lens having a first refractive index and
a second lens having a second refractive index, the second refractive index being higher than the refractive index of air and lower than the first refractive index, wherein the first and the second lens each have an outer surface and a generally aspherical critical refractive surface, said critical refractive surfaces having complementary shapes and being arranged in direct contact with each other such that a refractive interface for the lens system is formed between the first and the second lens.

2. The lens system according to claim 1, in which the outer surface of the first lens is flat.

3. The lens system according to claim 1, in which the outer surface of the second lens is flat.

4. The lens system according to claim 1, in which the first lens is made from a solid material, and the second lens is made from a liquid material, the first lens being submerged in said liquid material and the liquid material being enclosed in a transparent container.

5. The lens system according to claim 1, in which both the first and the second lens are made from a solid material.

6. The lens system according to claim 5, in which the first lens is made from quartz and the second lens is made from glass.

7. A method of manufacturing a screen for a CRT using the lens system as claimed in claim 1.
